(19) United States
(12) Patent Application Publication
(10) Pub. No.: US 2025/0025888 A1
(43) Pub. Date: Jan. 23, 2025

(54) AIR FILTERING DEVICE AND VEHICLE AIR CONDITIONER EQUIPPED THEREWITH

(71) Applicants: MAHLE INTERNATIONAL GMBH, Stuttgart (DE); KARLSRUHER INSTITUT FÜR TECHNOLOGIE, Eggenstein-Leopoldschafen (DE)

(72) Inventors: Andrei BOLOGA, Stutensee (DE); Daniel EBERLE, Ludwigsburg (DE); Sven PETZNER, Welzheim (DE); Hans-Joachim GEHRMANN, Weingarten (DE)

(21) Appl. No.: 18/770,901

(22) Filed: Jul. 12, 2024

(30) Foreign Application Priority Data
Jul. 18, 2023 (DE) 102023206804.4

(51) Int. Cl. B03C 3/12; B01D 46/00; B03C 3/155; B03C 3/41; B03C 3/47; B03C 3/60; B03C 3/66; F24F 8/192

(52) U.S. Cl. CPC B03C 3/12; B01D 46/0032; B03C 3/155; B03C 3/41; B03C 3/47; B03C 3/60; B03C 3/66; F24F 8/192; B01D 2279/40; B01D 2279/50; B03C 2201/10; B03C 2201/30

(57) ABSTRACT

An air filtering device through which a flow path for air passes is provided. It contains an ionizer in the flow path and an electrostatically charged filter downstream of the ionizer in the flow path, such that air can flow through the ionizer and filter. The ionizer also contains an electrode for generating a corona discharge that can be electrically connected to a high voltage source for the air filtering device, a counter electrode dedicated to the electrode, and an electrically conductive grid element upstream of the ionizer in the flow path. Substantial to the invention is that the counter electrode is electrically connected to an electrically conductive, flat, filtering layer in the filter. A vehicle air conditioner that contains at least one such air filtering device is provided.

### CROSS-REFERENCE TO RELATED APPLICATIONS

This application claims priority from German Patent Application No. 102023206804.4, filed on Jul. 18, 2023, the entirety of which is hereby fully incorporated by reference herein.

The invention relates to an air filtering device according to the preamble of claim 1. The invention also relates to a vehicle air conditioner that is equipped with at least one air filtering device.

An air filtering device of this type is disclosed in WO 2020 263 171 A1. Other air filtering devices are described in EP 3 056 364 B1, US 20 210 021 107 A1, WO 2021 226 639 A2, KR 102 205 159 B1, EP 3 488 933 A1, and US 2 016 229 267 A1.

Air filtering devices of this type are used for removing pollutants such as particulate matter, noxious gasses, and unpleasant odors from air. They are used in particular in vehicle air conditioners where they filter the air introduced from the environment into a passenger compartment in a vehicle. This results in a pleasant and healthy indoor atmosphere with higher air quality.

Urban environments pose a challenge for these air filtering devices. The air there can have high contents of potentially hazardous particulate matter. By way of example, city air may have pollutant levels that are significantly higher that the daily average PM_{2.5} recommended by the World Health Organization of 15 μg/m³. These conditions are challenging for air filtering devices, which must be able to provide a high level of filtering in these areas for such particles over long, uninterrupted periods of operation, without requiring maintenance.

To achieve this, manufacturers of these air filtering devices have started electrostatically charging the filters used therein in the production process. Consequently, the particles in the air can be filtered out not only mechanically, but also through electrostatic effects. This electrostatic filtering can reliably remove the smallest particles, in particular particulate matter, from the air.

Unfortunately, the electrostatic charge in a filter weakens over time as the filter ages and/or becomes clogged. This results in a reduction in electrostatic removal, which frequently comprises the majority of the filtering process.

Corona discharge ionizers are used to facilitate the electrostatic filtering of the filter. The ionizers generate a corona discharge (positive or negative polarity), which generates electrons and ions that ionize gas molecules. These ionized gas molecules then bond with the particles in the air, thus improving the electrostatic filtering effect of the filter. Nevertheless, after longer periods of operation, existing air filtering devices can no longer satisfy the filtering requirements. This then requires maintenance and potentially replacing the filter. If this is not done, the passengers may be exposed to high levels of particulate contamination.

The object of the invention is to therefore create an improved or at least different embodiment of an air filtering device. In particular, a vehicle air conditioner is to be obtained that has at least one such air filtering device.

This is achieved with the subject matter of the independent claims. Advantageous embodiments are the subject matter of the dependent claims and the description.

The invention acknowledges that the filtering obtained with a filter and the service life thereof can be increased with an improved polarization of the air filtering device in combination with an optimized ionization/particle charging.

An air filtering device is therefore proposed, in particular for an air conditioner for a vehicle interior, through which a flow path for air passes. The air filtering device contains an ionizer in the flow path for ionizing the air flow, and an electrostatically charged filter downstream of the ionizer for filtering the air flow, such that air can flow through the ionizer and the filter. Moreover, the ionizer has at least one electrode that is or can be electrically connected to a high voltage source for generating a corona discharge in the air flow, at least one counter electrode dedicated to the electrode, and a conductive, flat grid element upstream of the electrode and counter electrode, which functions as a counter electrode. It is essential that the at least one counter electrode is electrically connected to a conductive, flat filtering layer in the filter, and to the grid element. This results in an air filtering device with which an electric field is generated between the ionizer and the filter, resulting in a significantly improved filtering performance and longer service life of the filter through the polarization. The upstream grid element, which functions as a counter electrode for the at least one electrode, ensures an improved electrostatic charging of the particles in the air flow, resulting, in combination with the polarization effect, in an improvement in the filtering effect of the filter.

It is clear to the person skilled in the art that this ionization of the air flow means nothing other than an electrostatic charging of the gas molecules in the air, and the particles in the air flow.

Ideally, a first electrical potential is applied to the at least one electrode with the high voltage source, and a second electrical potential, differing from the first, is applied to the at least one counter electrode, the filtering layer, and the grid element, when the air filtering device is in use. This produces an electric field between the ionizer, comprising the at least one electrode, the counter electrode, and the grid element, and the filter. Because the potential for the counter electrode is also applied to the filter, a polarization effect can be obtained in the filter. This effect can substantially increase the filtering effect, even when the filter is old.

The first electric potential can be a supply potential and the second can be a counter-potential. This can also be reversed, such that the first potential is the counter-potential, and the second is the supply potential. The first potential can be negative, in which case the second is positive. It is also possible for the first potential to be positive, and the counter-potential to be negative.

Ideally, there is a negative or positive difference in potentials (voltage potential) between the at least one electrode and the at least one counter electrode, the filtering layer, and the grid element. This potential difference is determined by the difference between the first potential and the second potential.

This voltage or potential difference can be from −5 kV to −11 kV, preferably −7 kV. The at least one electrode can consequently generate a negative corona discharge, which results in a better ionization of the particles in the air than a positive corona discharge, and therefore a better filtering by the air filtering device. Nevertheless, the air filtering device can also be designed and operated such that the at least one electrode in the air flow results in a positive corona discharge.

Ideally, the ionizer is at a spacing of 0 mm to 30 mm, preferably 7 mm, from the downstream filter. The at least one electrode can be at a spacing of 20 mm to 50 mm, preferably 30 mm, from the upstream grid element. This results in an ionization in the air filtering device with which the particles in the air flow are charged. This also generates an advantageous polarization effect in the filter element. The combination of these effects results in a high level of particle removal. This also results in a compact air filtering device, such that it can fit into the installation space available in a vehicle air conditioner. The invention acknowledges that a spacing between the ionizer and filter of 7 mm, and a spacing between the ionizer and grid element of 30 mm, results in a better relationship between the level of particle removal and the size of the air filtering device.

The grid element preferably has a mesh size of 1 mm to 6 mm, preferably 3 mm. The term “mesh size” refers the distance between adjacent nodes in the grid element. The grid element can also have a mesh area of 1×1 mm² to 6×6 mm², preferably 3×3 mm². This refers to the area of an aperture in the mesh forming the grid element. Stainless steel can be used to obtain a durable grid element.

The filter can also contain a layer for removing particles. This layer is made of a poorly conductive, or electrically insulating, material. In particular, it can form an electrostatic field.

Ideally, this layer (also referred to as a dielectric layer) is placed on the filtering layer on the upstream side of the filter facing the ionizer and the air flow. This dielectric layer is therefore upstream of the filtering layer, such that air first flows through it, before reaching the filtering layer. The dielectric layer is preferably the layer of the filter with which particles are removed.

The filtering layer can also contain a layer of activated carbon, or be made thereof. This filtering layer can remove noxious gases and unpleasant odors form the air flow. The activated carbon layer is downstream of the dielectric layer in the air flow.

The filter is ideally a pleated filter.

The at least one electrode and at least one counter electrode can have a variety of designs. A pointed electrode (needle-shaped or conical) with a central axis, and an annular or cylindrical counter electrode delimiting an inner volume, are advantageous. This allows the electrode body to be placed such that its central axis is parallel and preferably coaxial to the central axis of the counter electrode body. The tip of the needle-shaped or conical electrode body can also face into the air flow. The diameter of the counter electrode body is ideally 40 mm to 90 mm, preferably 50 mm. More durable electrodes and counter electrodes can be obtained when they are made of stainless steel. The grid element, which forms a counter electrode, can also be made of stainless steel.

The air filtering device ideally contains two or more electrodes and two or more counter electrodes, each of which is dedicated to an electrode, in which the electrodes are electrically connected to one another, and the counter electrodes are electrically connected to one another. The air filtering device can also contain at least one additional electrode and at least one additional counter electrode, which is dedicated to the at least one additional electrode. The at least one electrode and at least one additional electrode are electrically connected to one another. The at least one counter electrode and at least one additional counter electrode can also be electrically connected to one another. The air filtering device therefore has an assembly composed of at least two electrodes, and an assembly composed of at least two counter electrodes, each of which are dedicated to one of the at least two electrodes. The air filtering device can also contain numerous electrodes and counter electrodes, each of which are electrically connected to one another, and dedicated to electrodes, each of which are also electrically connected to one another.

The invention also relates to a vehicle air conditioner, which can be installed in a vehicle and used for the passenger compartment of the vehicle. It is essential that the air conditioner is equipped with at least one air filtering device, as described above. This results in an advantageous vehicle air conditioner that will continue to function properly over a comparatively long service life, resulting in better air quality in the passenger compartment.

In summary, the present invention relates to an air filtering device through which a flow path for air passes. It contains an ionizer in the flow path, and an electrostatically charged filter downstream of the ionizer, through both of which air can flow. The ionizer contains an electrode for generating a corona discharge that can be electrically connected to a high voltage source for the air filtering device, a counter electrode dedicated to the electrode, and an electrically conductive grid element upstream of the electrode, which preferably functions as an additional counter electrode. Substantial to the invention is that the counter electrode is electrically connected to a conductive, flat, filtering layer in the filter, and to the grid element. The invention also relates to a vehicle air conditioner that contains at least one such air filtering device.

Further features and advantages of the invention can be derived from the dependent claims, drawings, and associated descriptions thereof.

It is understood that the features described above and explained below can be used not only in the given combinations, but also in other combinations or in and of themselves, without abandoning the scope of the present invention.

Preferred embodiments of the invention are shown in the drawings and shall be explained in greater detail below, in which the same reference symbols are used for identical, similar, or functionally identical components.

Therein, schematically:

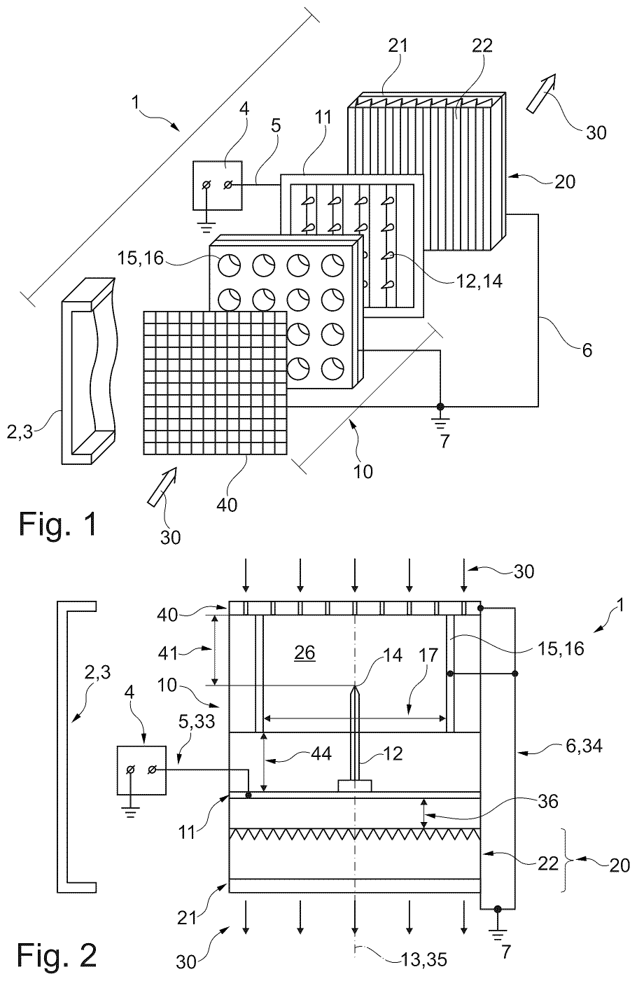

FIG. 1 shows a simplified perspective view of a preferred embodiment of an air filtering device, and

FIG. 2 shows a side view of the air filtering device from FIG. 1.

FIGS. 1 and 2 show a preferred, simplified embodiment of an air filtering device 1, preferably forming a vehicle interior air filtering device, which is installed in a housing 3 for a vehicle air conditioner 2 in a vehicle, not shown.

The air flows through the air filtering device 1 in the direction indicated by the arrow 30 in FIGS. 1 and 2. This air flow is composed of the air outside the vehicle or air circulating inside the vehicle, or a mixture of the air outside the vehicle and the air circulating inside the vehicle, which has been drawn in from the environment and conducted into a passenger compartment, not shown in the drawing. The air flow contains undesired particles, noxious gasses, and unpleasant odors, which are to be filtered out of the air flow by the air filtering device 1. The air filtering device 1 has an ionizer 10 for this in the flow path 30, which ionizes the air flow, and an electrostatically charged filter 20 downstream of the ionizer 10 in the flow path 30 for filtering the air flow. FIGS. 1 and 2 show that the air flow flows entirely through the ionizer 10 and the filter 20.

The ionizer 10 in the air filtering device 1 contains numerous electrodes 11 lying in the same plane, each of which generates a corona discharge. They have needle-shaped or conical electrode bodies 12, which are indicated in FIGS. 1 and 2 by simple cones. The electrode bodies 12 each have a central axis 13 through their main directions of extension, and also have a tip 14 facing into the air flow, see FIG. 2. These electrodes 11 are also electrically connected by a first electrical line 5 to a high voltage source 4 for the air filtering device 1, indicated by a simple box in FIGS. 1 and 2. The high voltage source 4 supplies the electrodes 11 with an electrical potential.

The ionizer 10 also contains numerous counter electrodes 15, which lie in the same plane and are each dedicated to an electrode 11. The counter electrodes 15 each have an annular or cylindrical body 16 with an inner diameter 17 of 40 mm to 90 mm, preferably 50 mm. These counter electrode bodies 16 also delimit an internal volume 26. The counter electrode bodies 16 are also made of stainless steel, like the electrodes 11, for durability. FIGS. 1 and 2 show that the counter electrodes 15 and electrodes 11 are arranged in relation to one another such that the electrode bodies 12 are aligned with the middles of the counter electrode bodies 16 and placed substantially entirely, or entirely, within the internal volumes 26 of the counter electrode bodies 16. The electrode bodies 12 are ideally placed in the respective internal volumes 26 such that their central axes 13 are parallel and coaxial to the central axes 35 of the counter electrode bodies 16.

The ionizer 10 in the air filtering device 1 also contains a flat grid element 40 upstream 11 of the electrodes 11 in the flow path 30, which is made of an electrically conductive material, e.g. stainless steel. Purely by way of example, it has a mesh size of 1 mm to 6 mm, preferably 3 mm, such that the air can flow freely through it. It also functions as an additional counter electrode, resulting in an effective ionization of the particles in the air flow.

The filter 20 in the air filtering device 1 can be pleated and/or made of a single piece. In the present example, it has a layered structure, comprising an electrically conductive filtering layer 21 and a dielectric layer 22 for removing particles. It can also contain additional layers. The filtering layer 21 can contain an activated carbon layer, or be made entirely thereof. The dielectric layer 22 is ideally made of a poorly conductive or electrically insulating material, and placed on the filtering layer 21 on the upstream side 23 of the filter 20 facing the ionizer and the air flow. The dielectric layer 22 is therefore upstream in the air flow, such that air first flows through it, prior to the filtering layer 21.

The ionizer 10 is placed in relation to the filter 20 such that there is a spacing 36 of 0 mm to 30 mm, preferably 7 mm therebetween.

The grid element 40 is placed in relation to the electrode tips 14 such that there is a spacing 41 (H1) of 20 mm to 50 mm, preferably 30 mm, therebetween.

The minimum spacing 44 (H2) between the counter electrodes 15 and the electrodes 11 in the direction (arrow 30) of the air flow is equal to or greater than one half of the inner diameter of the electrode bodies 16, e.g. 20 mm to 45 mm, ideally 25 mm.

Substantial to the invention is that the counter electrodes 15 are electrically connected by a second electric line 6 to the electrically conductive filtering layer 21 in the filter 20, and to the grid element 40, which functions as an additional counter electrode. This results in a first electric potential 33 being supplied to the electrodes 11 by the high voltage source 4 when the air filtering device 1 is in use, while the counter electrodes 15, filtering layer 21, and grid element 40 are supplied with a second electric potential 34, that differs from the first 33. By way of example, the first electric potential 33 can be a supply potential, and the second 34 can be a counter-potential. The latter is obtained in this case in that the second electric line 6 is connected to a counter-potential terminal 7. This results in a potential difference between the first electric potential 33 and the second electric potential 34, which can be between −5 kV and −11 kV, preferably −7 kV.

This results in the following: when the air filtering device 1 is in use, the air flow flows through the air filtering device 1, in which undesired particles such as particulate matter, noxious gasses, and unpleasant odors, are conducted past the ionizer 10. The electrodes 11 are connected to the first electric potential 33, such that a potential difference of e.g. −7 kV is obtained between the electrodes 11 and the counter electrodes 15, the filter layer 21, and the grid element 40. This generates corona discharges near the electrode tips 14, electrostatically ionizing gas molecules in the air flow. The ionized gas molecules then bond with the particles in the air flow, such that they also can be regarded as electrostatically charged. The counter electrodes 15, filtering layer 21, and grid element 40, all of which are connected to the counter-potential, form a counter potential to the electrodes 11. This results in the formation of an electrostatic field between the electrodes 11 and the filter 20 when the air filtering device 1 is in use. This electrostatic field polarizes the filter 20. This increases the precipitation of the charged particles as a result of the corona discharge particle charging and electrostatic polarization phenomena within the filter layers.

The specification can be readily understood with reference to the following Representative Paragraphs:
Representative Paragraph 1. An air filtering device (1), in particular a vehicle interior air filtering device for a vehicle air conditioner (2),
   through which a flow path (30) for an air flow passes,
   wherein the air filtering device (1) contains an ionizer (10) for ionizing the air flow in the flow path (30), and an electrostatically charged filter (20) for filtering the air flow downstream of the ionizer (10), such that the air flow can flow through the ionizer (10) and filter (20),
   wherein the ionizer (10) contains at least one electrode (11) for generating a corona discharge in the air flow, that is or can be electrically connected to a high voltage source (4) for the air filtering device (1), at least counter electrode (15) that is dedicated to the at least one electrode (11), and an electrically conductive, flat, grid element (40) upstream of the at least one electrode (11) in the flow path (30),
   characterized in that
   the at least one counter electrode (15) is electrically connected to an electrically conductive, flat, filtering layer (21) in the filter (20), and to the grid element (40).
Representative Paragraph 2. The air filtering device (1) according to Representative Paragraph 1, characterized in that
   a first electric potential (33) is or can be applied to the at least one electrode (11), and a second electric potential (34), which is different from the first electric potential (33), is or can be applied to the at least one counter electrode (15), the filtering layer (21), and the grid element (40), when the air filtering device (1) is in use.
Representative Paragraph 3. The air filtering device (1) according to Representative Paragraph 1 or 2, characterized in that
   the first electric potential (33) is a supply potential and the second electric potential (34) is the counter-potential thereto, or vice versa.
Representative Paragraph 4. The air filtering device (1) according to any of the preceding Representative Paragraphs, characterized in that
   a negative or positive potential difference is or can be applied between the at least one electrode (11) and the at least one counter electrode (15), the filtering layer (21), and the grid element (40), when the air filtering device (1) is in use.
Representative Paragraph 5. The air filtering device (1) according to Representative Paragraph 4, characterized in that
   the negative potential difference is −5 kV to −11 kV, or preferably −7 kV.
Representative Paragraph 6. The air filtering device (1) according to any of the preceding Representative Paragraphs, characterized in that
   the ionizer (10) has a first spacing (36) to the downstream filter (20) of 0 mm to 30 mm, preferably 7 mm, and/or
   the electrodes (11) have a second spacing (41) to the upstream grid element (40) of 20 mm to 50 mm, preferably 30 mm.
Representative Paragraph 7. The air filtering device (1) according to any of the preceding Representative Paragraphs, characterized in that
   the filter (20) contains a dielectric layer (22).
Representative Paragraph 8. The air filtering device (1) according to Representative Paragraph 7, characterized in that
   the dielectric layer (22) is placed on the filtering layer (21) on the upstream side (23) of the filter (20) facing the ionizer (10) and the air flow.
Representative Paragraph 9. The air filtering device (1) according to any of the preceding Representative Paragraphs, characterized in that
   the filtering layer (21) contains or is made of an activated carbon layer.
Representative Paragraph 10. The air filtering device (1) according to any of the preceding Representative Paragraphs, characterized in that
   the at least one electrode (11) has a needle-shaped or conical electrode body (12), which has a central axis (13),
   the at least one counter electrode (15) has an annular or cylindrical body (16), which delimits an internal volume (26),
   wherein the electrode body (12) is placed in relation the counter electrode body (16) such that the central axis (13) of the electrode body (12) is parallel and preferably coaxial to the central axis (35) of the counter electrode (16),
   wherein the electrode body (12) is substantially or entirely inside the internal volume (26) of the counter electrode body (16), and
   wherein a tip (14) of the needle-shaped or conical electrode body (12) faces into the air flow.
Representative Paragraph 11. The air filtering device (1) according to any of the preceding Representative Paragraphs, characterized in that
   there are two or more electrodes (11) and two or more counter electrodes (15), which are each dedicated to the electrodes (11),
   wherein the electrodes (11) are electrically connected to one another,
   wherein the counter electrodes (15) are electrically connected to one another.
Representative Paragraph 12. A vehicle air conditioner (2) that contains at least one air filtering device (1) according to any of the preceding Representative Paragraphs.

1. An air filtering device, in particular a vehicle interior air filtering device for a vehicle air conditioner, comprising:
a flow path through which an air flow passes,
an ionizer configured to ionizing the air flow in the flow path, and an electrostatically charged filter configured to filter the air flow downstream of the ionizer, such that the air flow can flow through the ionizer and filter,
wherein the ionizer comprises at least one electrode configured to generate a corona discharge in the air flow, that is or is configured to can be electrically connected to a high voltage source for the air filtering device, at least counter electrode that is dedicated to the at least one electrode, and further comprising an electrically conductive, flat, grid element upstream of the at least one electrode in the flow path,
wherein the at least one counter electrode is electrically connected to an electrically conductive, flat, filtering layer in the filter, and to the grid element.

2. The air filtering device according to claim 1, wherein
a first electric potential is or is configured to be applied to the at least one electrode, and a second electric potential, which is different from the first electric potential, is or is configured to be applied to the at least one counter electrode, the filtering layer, and the grid element, when the air filtering device is in use.

3. The air filtering device according to claim 1, wherein
the first electric potential is a supply potential and the second electric potential is the counter-potential thereto, or vice versa.

4. The air filtering device according to claim 1,
a negative or positive potential difference is or is configured to be applied between the at least one electrode and the at least one counter electrode, the filtering layer, and the grid element, when the air filtering device is in use.

5. The air filtering device according to claim 4, wherein
the negative potential difference is −5 kV to −11 kV.

6. The air filtering device according to claim 1, wherein characterized in that
the ionizer has a first spacing to the downstream filter of 0 mm to 30 mm, and/or
the electrodes have a second spacing to the upstream grid element of 20 mm to 50 mm.

7. The air filtering device according to claim 1, wherein
the filter contains a dielectric layer.

8. The air filtering device according to claim 7, wherein
the dielectric layer is placed on the filtering layer on the upstream side of the filter facing the ionizer and the air flow.

9. The air filtering device according to claim 1, wherein
the filtering layer contains or is formed from an activated carbon layer.

10. The air filtering device according to claim 1, wherein
the at least one electrode has a needle-shaped or conical electrode body, which has a central axis,
the at least one counter electrode has an annular or cylindrical body, which delimits an internal volume,
wherein the electrode body is placed in relation the counter electrode body such that the central axis of the electrode body is parallel and coaxial to the central axis of the counter electrode,
wherein the electrode body is substantially or entirely inside the internal volume of the counter electrode body, and
wherein a tip of the needle-shaped or conical electrode body faces into the air flow.

11. The air filtering device according to claim 1, wherein
there are two or more electrodes and two or more counter electrodes, which are each dedicated to the electrodes,
wherein the electrodes are electrically connected to one another,
wherein the counter electrodes are electrically connected to one another.

12. A vehicle air conditioner that contains at least one air filtering device according to claim 1.

13. The air filtering device of claim 5, wherein the negative potential difference is −7 kV.

14. The air filtering device of claim 6, wherein the first spacing between the ionizer and the downstream filter is 7 mm, and the electrodes have a second spacing the upstream grid element of 30 mm.
